(19) United States
(12) Patent Application Publication
(10) Pub. No.: US 2026/0075145 A1
(43) Pub. Date: Mar. 12, 2026

(54) EMERGENCY COMMUNICATION SYSTEM THAT SUPPORTS MULTIPLE COMMUNICATION MEDIUMS

(71) Applicant: R W Young Enterprises LLC, Saint Louis, MO (US)

(72) Inventor: Rochele Young, St. Louis, MO (US)

(21) Appl. No.: 19/227,863

(22) Filed: Jun. 4, 2025

Related U.S. Application Data
(60) Provisional application No. 63/692,050, filed on Sep. 7, 2024.

(51) Int. Cl. H04M 11/04

(52) U.S. Cl. CPC H04M 11/04

(57) ABSTRACT

An emergency communication system receives an incoming communication and generates a user interface in response to receiving the communication. The user interface supports many different types of communications. The user interface is also accessible by multiple different computing devices simultaneously.

### CROSS-REFERENCE TO RELATED APPLICATION

This application in a non-provisional application of, and claims priority to, U.S. Provisional Patent Application No. 63/692,050, filed Sep. 7, 2024 and entitled Emergency Communication System That Supports Mutlipe Communication Mediums”, the entire disclosure of which is hereby incorporated by reference in its entirety.

### BACKGROUND

In an emergency situation, individuals often call 9-1-1 and verbally communicate with an operator on the receiving end. However, there may be situations in which an individual cannot verbally communicate with the operator. For example, the individual may be in a situation in which verbal communication is not possible or safe. In another example, the individual may have a speech impediment or may not otherwise be able to effectively verbally communicate. As a result, the individual may not receive the help or the assistance they are seeking.

### SUMMARY

The present application describes an emergency communication system that supports multiple different communications mediums or communication types. In an example, the emergency communication system supports the multiple different communication mediums in a single user interface. For example, when an incoming communication (e.g., from a computing device) is received, the emergency communication system determines or identifies one or more characteristics associated with the incoming communication. When the one or more characteristics of the incoming communication are determined, the emergency communication system identifies the type of the incoming communication.

In an example, the type of the incoming communication is a text message. In another example, the type of the incoming communication is a video communication. In yet another example, the type of the incoming communication is a voice communication. In other examples, the incoming communication may be a combination of voice, text and/or video. The emergency communication system then initiates a communication session with the computing device in the user interface based, at least in part, on the identified type of the incoming communication.

In an example, the emergency communication system enables the incoming communication to be switched between communication types. For example, if the incoming communication is initially a verbal or voice communication, but the individual that initiated the call switches to a video communication, the user interface displays the incoming video communication. In another example, the user interface enables the operator to switch between communication types. For example, if the incoming communication is a text communication, the user interface may display the text communication but enable the operator to provide text input and/or verbal input. The verbal input may be changed to text and provided to the individual that initiated the communication (e.g., either via text or voice).

In yet another example, the emergency communication system detects a language of the incoming communication and provides translations services. For example, if the incoming communication is in Spanish, the emergency communication system may change Spanish to English. Likewise, the emergency communication system can translate operator instructions from English to Spanish.

Accordingly, examples of the present disclosure describe a method for receiving an emergency communication from a computing device. In an example, the method includes receiving an incoming communication and identifying one or more characteristics of the incoming communication. The method also includes identifying a type of the incoming communication based, at least in part, on the one or more characteristics. A communication session is initiated in a user interface based, at least in part, on the identified type of the incoming communication.

Other examples describe an emergency communication system that includes at least one processor and a memory coupled to the at least one processor. In an example, the at least one memory stores instructions that, when executed by the at least one processor, perform operations that include identifying one or more characteristics associated with a received communication and identifying a type of the received communication based, at least in part, on the one or more characteristics. The emergency response system also initiates a communication session in a user interface based, at least in part, on the identified type of the incoming communication. In an example, the user interface supports multiple different types of communications.

The present disclosure also describes a method that includes receiving an emergency communication from a remote computing device. Based on receiving the emergency communication, a communication type of the emergency communication is identified. A user interface is launched. In an example, the user interface has one or more features adapted to communicate with the computing device based, at least in part, on the communication type of the emergency communication.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1A-FIG. 1B illustrate a communication system that includes an emergency communication system according to an example.

FIG. 2 illustrates a user interface for an emergency communication system according to an example.

FIG. 3 illustrates a method for initiating a communication session in a user interface associated with an emergency response system according to an example.

FIG. 4 is a block diagram illustrating physical components (e.g., hardware) of a computing device according to an example.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. The following detailed description is therefore not to be taken in a limiting sense, and the scope of the present disclosure is defined by the appended claims and their equivalents.

Individuals often call 9-1-1 when faced with an emergency. After dialing, the individual verbally communicates with an operator. During the communication, the individual provides details about the emergency, the location of the emergency and other important information. During the call, the operator often provides instructions and/or encouragement to the individual.

However, there may be situations in which an individual cannot verbally communicate with the operator. For example, the individual may be in a situation in which verbal communication is not possible or safe. In another example, the individual may have a speech impediment or may not otherwise be able to effectively verbally communicate. As a result, the individual may not receive the help or the assistance they are seeking.

To address the above, the present application describes an emergency communication system that supports multiple different communications mediums or communication types. For example, the communication system supports text-based communications, voice-based communications, and/or video-based communications. As will be described in greater detail herein, in an example, the emergency communication system supports the different types of communications in a single user interface. Additionally, the single user interface may be accessible to many different computing devices simultaneously or substantially simultaneously.

For example, when an incoming communication (e.g., from a computing device) is received, the emergency communication system determines or identifies one or more characteristics of the incoming communication. The one or more characteristics of the incoming communication are used to identify whether the received communication is a text-based communication, a voice-based communication and/or a video-based communication.

When the communication type or medium is determined, the emergency communication system initiates a communication session with one or more computing devices (e.g., a computing device that sent an initial communication and a computing device that receives or will receive the initial communication) using the user interface.

For example, if the incoming or the received communication is a text-based communication, the emergency communication system initiates a text-based communication session, including an application this is being used to send/receive the text-based communication, between two or more computing devices in the user interface. As a result, the computing device of the individual that initiated the communication and the computing device of the operator of the emergency response system can communicate via text message. In another example, if the communication initiated by the individual is a voice-based communication, the emergency communication system initiates a voice-based communication session in the user interface.

In an example, the emergency communication system hosts the user interface and enables one or more computing devices to access the user interface. In another example, at least one of the computing devices hosts the user interface and allows one or more computing devices to access the user interface.

When a communication session has been initiated, the emergency communication system also enables the communication session to be switched between communication types. For example, if the incoming communication is initially a verbal or voice-based communication, the emergency communication system enables the communication session to be changed to a text-based communication session and/or a video-based communication session.

In yet another example, the emergency communication system detects a language of the incoming communication and provides translation services. For example, if the incoming communication is in Spanish, the emergency communication system may change Spanish to English (or to a language understood by the operator). Likewise, the emergency communication system can translate operator instructions from English to Spanish.

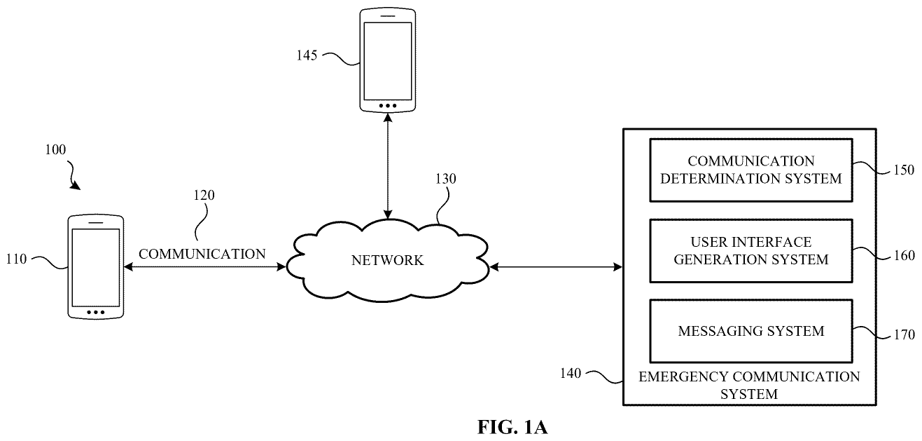

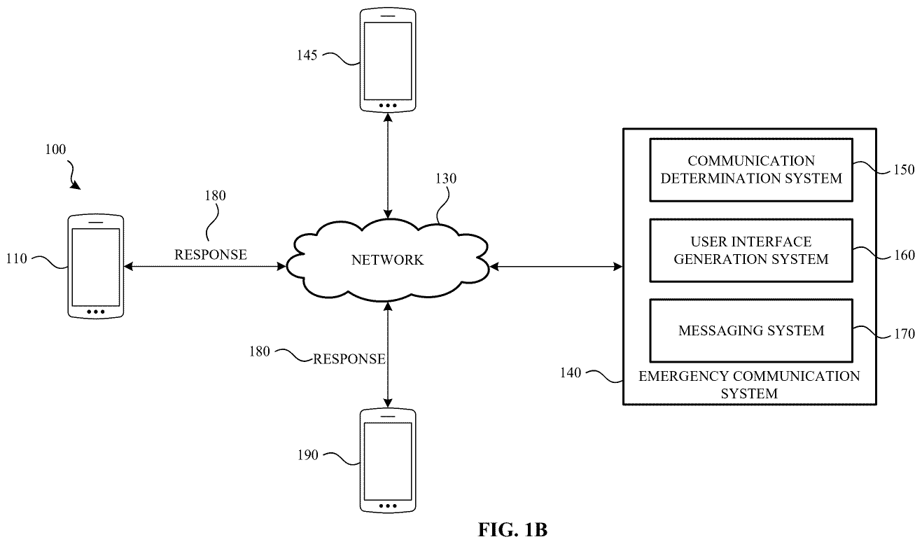

These and other examples will be shown and described in greater detail with respect to FIG. 1A-FIG. 4.

FIG. 1A-FIG. 1B illustrate a communication system 100 that includes an emergency communication system 140 according to an example. In an example, the emergency communication system 140 may be used with, or may otherwise be part of, a 9-1-1 emergency system. Although a 9-1-1 emergency system is specifically mentioned, the emergency communication system 140 may be integrated with and/or into any type of communication system.

As shown in FIG. 1A, the emergency communication system 140 includes a communication determination system 150, a user interface generation system 160 and a messaging system 170. Each of the systems described herein may be integrated with other or may be separate systems. Each of the various systems shown and described with respect to FIG. 1A and FIG. 1B will be described in greater detail below.

In an example, the emergency communication system 140 is accessible by a computing device 110. The computing device 110 is any type of computing device 110 that is capable of establishing a communication session with the emergency communication system 140. For example, the computing device 110 is a mobile phone, a tablet computing device, a laptop, a gaming device, a set-top box, a television, a desktop computer or any other computing device having the ability to send and/or receive video, voice, and/or text-based communications.

In an example, the computing device 110 accesses the emergency communication system 140 through a network 130 or other communication channel. For example, when accessing the emergency communication system 140, the computing device 110 transmits a communication 120 to the emergency communication system 140 via the network 130. As previously indicated, the communication 120 may be any type of communication including, but not limited to, a text-based communication, a voice-based communication and/or a video-based communication.

When the communication 120 is received, the communication determination system 150 of the emergency communication system 140 identifies and/or determines one or more characteristics associated with the communication 120. In an example, the one or more characteristics are associated with metadata or other data provided by, or otherwise associated with, the communication 120. When the metadata, the data, or other information associated with the communication 120 is identified or determined, the communication determination system 150 uses the information to determine a type of the communication 120. For example, the communication determination system 150 uses the one or more characteristics to determine whether the communication 120 is a text-based communication, a voice-based communication and/or a video-based communication.

In addition to determining the one or more characteristics of the communication 120 to determine a type of the communication 120, the communication determination system 150 also utilize data, metadata and/or information associated with the communication 120 to determine various additional features or characteristics associated with the communication 120. For example, the communication determination system 150 may determine location information associated with the computing device 110. In another example, the communication determination system 150 may determine a language (e.g., Spanish, English) in which the communication is or will be presented. In yet another example, the communication determination system 150 may parse or analyze content in the communication 120 (e.g., when the communication 120 is a text-based communication) to identify the type of emergency the individual that initiated the communication 120 is experiencing, a name of the individual, a location (e.g., GPS information or other location information) of the individual and so on.

When the determination as to the communication type is made, the user interface generation system 160 generates, displays and/or enables the emergency communication system 140 to host the user interface. For example, the emergency communication system establishes a communication session, via the user interface, between the computing device 110 associated with the individual and a computing device 145 associated with an operator of an emergency response system (e.g., a 9-1-1 operator). For example, the emergency communication system 140 hosts the user interface and enables the computing device 110 and the computing device 145 to access the user interface.

In an example, the user interface that is generated, displayed and/or hosted is specific to the determined type of the communication 120. For example, if the communication 120 is determined to be a text-based communication, the user interface has various features that enable an operator and the individual associated with the computing device 110 to communicate via text. For example, the user-interface may have various chat features and/or capabilities.

In other examples, the user interface may have speech to text and/or text to speech capabilities. In such an example, the operator or user of the emergency communication system may be able to speak instructions to the individual and the emergency communication system converts the verbal communication to text-based communications and provides the text-based communication to the computing device 110.

In another example, the user interface generate system 160 generates a single user interface that includes sections or portions that are dedicated to particular types of communications. For example, the user interface may be divided into at least two sections - a first section adapted to receive and/or send a first type of communication (e.g., text-based communications) and a second section adapted to receive and/or send a second type of communication (e.g., video and/or verbal-based communications). In this example, the operator associated with the computing device 145 may be able to receive and/or send various communications in either section simultaneously, substantially simultaneously and/or in series.

For example, the user interface generated by the user interface generate system 160 may enable the computing device 110 to transmit video-based communications. This would allow the operator associated with the computing device 145 to see video of the individual including, but not limited to, the environment the individual is in, whether the individual is injured, whether the individual is using sign language, and so on.

However, the user interface may also enable the operator to respond to the individual via voice or text. In an example, the user interface may overlay the text on the video. In another example, the text may be provided in another portion of the user interface. In some examples, the user interface is provided on the computing device 110 and/or on a computing device associated with the emergency communication system 140. As a result, both the operator and the individual may access a similar user interface hosted by the emergency communication system 140.

In an example and as briefly described above, when the user interface has been launched and/or when a communication session has been established between the computing device 110 and the computing device 145 via the emergency communication system 140, the messaging system 170 enables various responses to be generated and transmitted between the various computing devices.

For example and referring to FIG. 1B, when the communication 120 has been received, the user interface has been launched and/or created and/or the communication session between the various computing devices has been initiated/established, the operator may provide one or more responses 180 within the user interface. As previously indicated, the response 180 is then transmitted, via the network 130, to the computing device 110.

In some examples, the messaging system 170 includes translation services. For example, if the messaging system can automatically translate the response 180 from a first language to a second language.

In another example, the messaging system 170 may also transmit the response and/or information associated with the communication 120, to another computing device 190. For example, the computing device 190 may be a computing device associated with emergency response personnel (e.g., a law enforcement office, an ambulance technician, a doctor). In an example, the computing device 190 may also access and/or be granted (e.g., by the computing device 145) access to the user interface. As a result, the emergency response personnel may be apprised in real time, or substantially real time, of the emergency and/or situation they will be entering.

In an example, and because the computing device 190 is granted access to the user interface, emergency response personnel associated with the computing device 190 may also be able to provide input the user interface, generate responses and/or receive communications 120 from the computing device 110. For example, the computing device 110, the computing device 190 and/or the computing device 145 may each access the same (or a similar user interface) and provide input to, and receive output from, a single, common, and/or shared user interface.

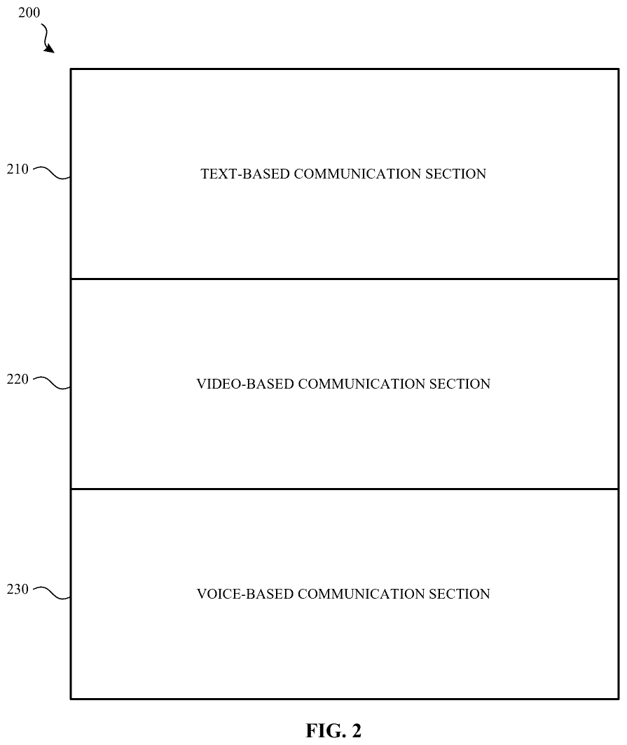

FIG. 2 illustrates a user interface 200 for an emergency communication system according to an example. In an example, the user interface 200 is generated by the user interface generation system (e.g., the user interface generation system 160 (FIG. 1A)) of an emergency communication system (e.g., the emergency communication system 140 (FIG. 1A)) in response to a received communication from a computing device.

In an example, the user interface 200 includes various sections and each section is dedicated to a particular type of communication or communication medium. For example, the user interface 200 includes a text-based communication section 210, a video-based communication section 220 and voice-based communication section 230. Although three sections and shown and described, the user interface may include more sections or fewer sections. For example, two or more of the sections may be combined into a single section.

In an example, each section may be associated with an input mechanism (e.g., a keyboard, a mouse, a microphone, a camera) and/or an output mechanism (e.g., a speaker, a monitor). As such, when the user interface 200 is provided on a computing device, an individual can select and/or switch between the various sections and receive communications and/or provide responses within, each section.

In some examples, the user interface 200 is provided on, or hosted by, the emergency communication system. As such, each computing device that accesses the emergency communication system may access or share the same user interface 200. In another example, copies of the user interface are provided on each computing device and any input and/or output provided on the user interface is provided to each copy simultaneously or substantially simultaneously.

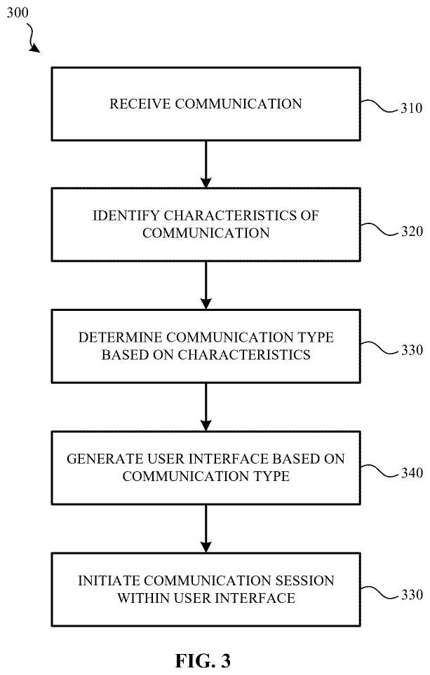

FIG. 3 illustrates a method 300 for initiating a communication session in a user interface associated with an emergency response system according to an example. In an example, the method 300 may be executed by the emergency communication system 140 shown and described with respect to FIG. 1A.

The method 300 begins when a communication is received (310) by the emergency communication system. In an example, the communication is transmitted to the emergency communication system from a computing device via a communication channel (e.g., a network). As previously discussed, the communication may be a text-based communication, a voice-based communication and/or a video-based communication.

When the communication is received, the emergency communication system identifies (320) one or more characteristics of the communication. In examples, the one or more characteristics are used to determine (330) a type of the communication.

When the type of communication is determined, the emergency communication system generates (340) a user interface based, at least in part, on the determined type of communication. In examples, in which the user interface includes multiple sections or portions, the emergency communication system populates at least one of the sections based on the determined type of communication.

The emergency communication system then initiates (350) a communication session between various computing devices via the user interface. In an example, the communication session is initiated between two computing devices and each computing device accesses the same user interface. For example, the user interface is hosted or provided by server or host device. Thus, when a communication session is established between computing devices, each computing device accesses the host device and the user interface. In an example, one or more of the computing devices may enable another computing device to join or otherwise access the user interface. In such examples, each computing device may provide input into and/or receive output on/from the user interface.

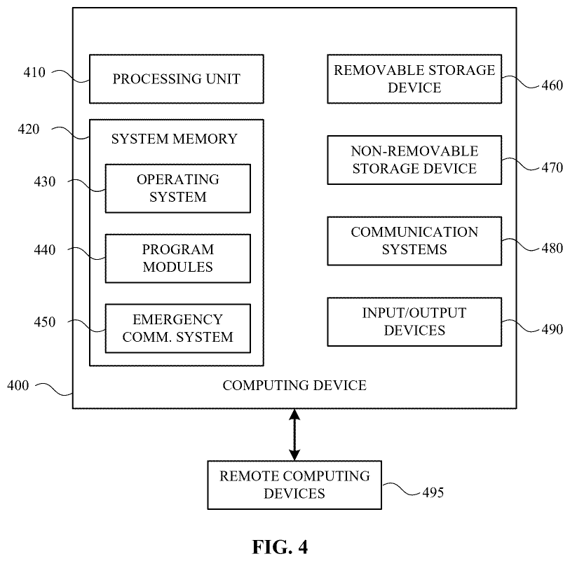

FIG. 4 and its associated descriptions provide a discussion of an example computing device that may be used with the various systems described herein. However, the illustrated computing device is an example and is not limiting as a vast number of electronic device configurations may be utilized for practicing various aspects of the disclosure.

FIG. 4 is a block diagram illustrating physical components (e.g., hardware) of a computing device 400 according to an example. The computing device 400 may be integrated or otherwise associated with any of the systems described above with respect to FIG. 1A and FIG. 1B. The components of the computing device 400 described below may have computer executable instructions for determining a type of an incoming communication, generating a user interface and/or initiating a communication session between various computing devices such as described above.

In a basic configuration, the computing device 400 may include at least one processing unit 410 and a system memory 420. Depending on the configuration and type of computing device, the system memory 420 may comprise, but is not limited to, volatile storage (e.g., random access memory), non-volatile storage (e.g., read-only memory), flash memory, or any combination of such memories. The system memory 420 may include an operating system 430 and one or more program modules 440 or components suitable for performing the various operations described above.

The operating system 430 may be suitable for controlling the operation of the computing device 400. The system memory 420 may also an emergency communication system 450 that functions in the manner previously described.

The computing device 400 may have additional features or functionalities. For example, the computing device 400 may also include additional data storage devices (removable and/or non-removable) such as, for example, magnetic disks, optical disks, or tape. Such additional storage is illustrated in FIG. 4 by a removable storage device 460 and a non-removable storage device 470.

As stated above, a number of program modules 440 and data files may be stored in the system memory 420. While executing on the processing unit 410, the program modules 440 may perform the various processes including, but not limited to, the aspects, as described herein.

Furthermore, examples of the disclosure may be practiced in an electrical circuit comprising discrete electronic elements, packaged or integrated electronic chips containing logic gates, a circuit utilizing a microprocessor, or on a single chip containing electronic elements or microprocessors. For example, examples of the disclosure may be practiced via a system-on-a-chip (SOC) where each or many of the components illustrated in FIG. 4 may be integrated onto a single integrated circuit. Such an SOC device may include one or more processing units, graphics units, communications units, system virtualization units and various application functionality all of which are integrated (or “burned”) onto the chip substrate as a single integrated circuit.

When operating via an SOC, the functionality, described herein, with respect to the capability of client to switch protocols may be operated via application-specific logic integrated with other components of the computing device 400 on the single integrated circuit (chip). Examples of the disclosure may also be practiced using other technologies capable of performing logical operations such as, for example, AND, OR, and NOT, including but not limited to mechanical, optical, fluidic, and quantum technologies. In addition, examples of the disclosure may be practiced within a general-purpose computer or in any other circuits or systems.

The computing device 400 may also have one or more input/output device(s) 490. These include, but are not limited to, a keyboard, a trackpad, a mouse, a pen, a sound or voice input device, a touch, force and/or swipe input device, a display, speakers, a printer, etc. The aforementioned devices are examples and others may be used. The computing device 400 may include one or more communication systems 480 that allow or otherwise enable the computing device 400 to communicate with remote computing devices 495. Examples of suitable communication connections include, but are not limited to, radio frequency (RF) transmitter, receiver, and/or transceiver circuitry; universal serial bus (USB), parallel, and/or serial ports.

The term computer-readable media as used herein may include computer storage media. Computer storage media may include volatile and nonvolatile, removable and non-removable media implemented in any method or technology for storage of information, such as computer readable instructions, data structures, or program modules.

The system memory 420, the removable storage device 460, and the non-removable storage device 470 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 400. Any such computer storage media may be part of the computing device 400. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

The description and illustration of one or more aspects provided in the present disclosure are not intended to limit or restrict the scope of the disclosure in any way. The aspects, examples, and details provided in this disclosure are considered sufficient to convey possession and enable others to make and use the best mode of claimed disclosure.

The claimed disclosure should not be construed as being limited to any aspect, example, or detail provided in this disclosure. Regardless of whether shown and described in combination or separately, the various features (both structural and methodological) are intended to be selectively rearranged, included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

Aspects of the present disclosure have been described above with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks. Additionally, it is contemplated that the flowcharts and/or aspects of the flowcharts may be combined and/or performed in any order.

References to an element herein using a designation such as “first,” “second,” and so forth does not generally limit the quantity or order of those elements. Rather, these designations may be used as a method of distinguishing between two or more elements or instances of an element. Thus, reference to first and second elements does not mean that only two elements may be used or that the first element precedes the second element. Additionally, unless otherwise stated, a set of elements may include one or more elements.

Terminology in the form of “at least one of A, B, or C” or “A, B, C, or any combination thereof” used in the description or the claims means “A or B or C or any combination of these elements.” For example, this terminology may include A, or B, or C, or A and B, or A and C, or A and B and C, or 2A, or 2B, or 2C, or 2A and B, and so on. As an additional example, “at least one of: A, B, or C” is intended to cover A, B, C, A-B, A-C, B-C, and A-B-C, as well as multiples of the same members. Likewise, “at least one of: A, B, and C” is intended to cover A, B, C, A-B, A-C, B-C, and A-B-C, as well as multiples of the same members.

Similarly, as used herein, a phrase referring to a list of items linked with “and/or” refers to any combination of the items. As an example, “A and/or B” is intended to cover A alone, B alone, or A and B together. As another example, “A, B and/or C” is intended to cover A alone, B alone, C alone, A and B together, A and C together, B and C together, or A, B, and C together.

What is claimed is:

1. A method for receiving an emergency communication from a computing device, comprising:
receiving an incoming communication;
identifying one or more characteristics of the incoming communication;
identifying a type of the incoming communication based, at least in part, on the one or more characteristics; and
initiating a communication session in a user interface based, at least in part, on the identified type of the incoming communication.

2. The method of claim 1, wherein the user interface supports multiple communication types.

3. The method of claim 2, wherein the user interface is divided into at least two sections and wherein a first section is adapted for a first communication type of the multiple communication types and a second section is adapted for a second communication type of the multiple communication types.

4. The method of claim 3, further comprising automatically switching from the first section to the second section in response to the identified type of the incoming communication changing from a first type to a second type.

5. The method of claim 3, wherein an input provided in at least one section of the at least two sections is similar to the identified type of the incoming communication.

6. The method of claim 3, wherein an input provided in at least one section of the at least two sections is different from the identified type of the incoming communication.

7. The method of claim 6, further comprising altering the input provided in the at least one section to be similar to the identified type of the incoming communication.

8. The method of claim 1, further comprising receiving identification information associated with the incoming communication.

9. The method of claim 8, wherein the identification information is location information.

10. An emergency communication system, comprising:
at least one processor; and
a memory coupled to the at least one processor and storing instructions that, when executed by the at least one processor, perform operations, comprising:
identifying one or more characteristics associated with a received communication;
identifying a type of the received communication based, at least in part, on the one or more characteristics; and
initiating a communication session in a user interface based, at least in part, on the identified type of the received communication, wherein the user interface supports multiple different types of communications.

11. The emergency communication system of claim 10, wherein the user interface supports multiple different types of communications simultaneously.

12. The emergency communication system of claim 11, wherein the user interface is divided into a first section and a second section and wherein the first section is adapted for a first communication type of the multiple different types of communications and the second section is adapted for a second communication type of the multiple different types of communication types.

13. The emergency communication system of claim 12, further comprising instructions for switching between the first section and the second section in response to a trigger event.

14. The emergency communication system of claim 12, wherein an input provided in the first section is similar to the identified type of the received communication.

15. The emergency communication system of claim 12, wherein an input provided in the first section is different from the identified type of the received communication.

16. The emergency communication system of claim 15, further comprising instructions for altering the input provided in the first section to be similar to the identified type of the incoming communication.

17. A method, comprising:
receiving an emergency communication from a remote computing device;
identifying a communication type of the emergency communication; and
launching a user interface having one or more features adapted to communicate with the computing device based, at least in part, on the communication type of the emergency communication.

18. The method of claim 17, wherein the user interface is adapted to transmit text input to the computing device.

19. The method of claim 17, further comprising switching an input method associated with the user interface based, at least in part, on information associated with the emergency communication.

20. The method of claim 17, further comprising:
receiving an indication that the communication type of the emergency communication has switched from the communication type to another communication type; and
automatically switching a communication transmission to the computing device based, at least in part, on the indication.
